(19) United States
(12) Patent Application Publication
(10) Pub. No.: US 2022/0201945 A1
(43) Pub. Date: Jun. 30, 2022

(54) AIR CONDITIONING SYSTEM FOR PLANT CULTIVATION, AIR CONDITIONING SYSTEM FOR MUSHROOM CULTIVATION, AND AIR CONDITIONING SYSTEM WITH CARBON DIOXIDE CONCENTRATION REGULATING FUNCTION

(71) Applicant: SHINWA CONTROLS CO., LTD, Kawasaki-Shi (JP)

(72) Inventors: Syunji YAMAGUCHI, Kawasaki-Shi (JP); Koichiro AOKI, Kawasaki-Shi (JP); Kenji NISHIMURA, Kawasaki-Shi (JP)

(73) Assignee: SHINWA CONTROLS CO., LTD, Kawasaki-Shi (JP)

(21) Appl. No.: 17/594,559

(22) PCT Filed: Apr. 23, 2020
(86) PCT No.: PCT/JP2020/017513

§ 371 Date: Oct. 22, 2021

(30) Foreign Application Priority Data
May 9, 2019 (JP) 2019-089164
Feb. 6, 2020 (JP) 2020-019087

(51) Int. Cl. A01G 18/69

(52) U.S. Cl. CPC A01G 18/69

(57) ABSTRACT

An air conditioning system for mushroom cultivation according to an embodiment includes an air passageway (10) having an intake opening for taking air thereinto, and a supply opening connected to a cultivation chamber (100) for cultivating a mushroom; a temperature control apparatus (20) that controls a temperature of air flowing through the air passageway (10), and a return passageway (30) for returning air in the cultivation chamber (100) to the air passageway (10) between the intake opening and a position at which the temperature control apparatus (20) controls air in temperature.

### TECHNICAL FIELD

The present invention relates to an air conditioning system for plant cultivation, an air conditioning system for mushroom cultivation, and air conditioning system with a carbon dioxide concentration regulating function.

### BACKGROUND ART

Plant factories are recently becoming more and more popular. A plant factory is a system for systematically cultivating plants by controlling a temperature, humidity, etc., in a cultivation chamber for cultivating plants. Such a plant factory is used for cultivating vegetables, mushrooms and so on.

For example, JP2012-55204A discloses a system for artificially cultivating mushrooms in a cultivation chamber. In the cultivation of mushrooms, it is known that a carbon dioxide concentration in a cultivation chamber affects a shape and size of the mushrooms. Thus, in the cultivation of mushrooms, a carbon dioxide concentration in a cultivation chamber may be regulated by a gas concentration controller disclosed in Patent Document 1. A carbon dioxide concentration in the cultivation chamber is sometimes regulated by regulating a ventilation time based on the experience of a plant manager.

### DISCLOSURE OF THE INVENTION

In a general plant factory, outside air having been controlled in temperature is supplied to a cultivation chamber, and old air in the cultivation chamber is correspondingly discharged outside. However, in such a temperature control method, when a difference between a temperature of the outside air and a target temperature in the cultivation chamber is large, power consumption for the temperature control significantly may increase, resulting in a very high running cost.

As described above, when mushrooms are cultivated in a cultivation chamber, since a carbon dioxide concentration in a cultivation chamber affects a shape and size of the mushrooms, regulation of carbon dioxide concentration may be needed. Although Patent Document 1 discloses a device for controlling a carbon dioxide concentration, such a device is a special device which is generally expensive. In addition, since the mushroom cultivation usually requires a more humid environment than that of vegetables, power consumption for the humidity control may also increase. As a result, cost burden of the mushroom cultivation may be very serious.

The present invention has been made in view of the above circumstances. An object of the present invention is to provide a system capable of controlling very economically a space such as a plant cultivation chamber to a desired condition.

An air conditioning system for plant cultivation according to the present invention comprises:

an air passageway having an intake opening for taking air thereinto, and a supply opening connected to a cultivation chamber for cultivating a plant;

a temperature control apparatus that controls a temperature of air flowing through the air passageway; and

a return passageway for returning air in the cultivation chamber to the air passageway between the intake opening and a position at which the temperature control apparatus controls air in temperature.

The air conditioning system for plant cultivation according to the present invention allows air having been controlled in temperature by the temperature control apparatus and supplied to the cultivation chamber to be returned through the return passageway to the air passageway between the intake opening and the temperature control position by the temperature control apparatus, so that air taken from the intake opening and air having already been controlled in temperature by the temperature control apparatus can be met. This allows a temperature of the air controlled in temperature by the temperature control apparatus to come close to a target temperature of the cultivation chamber. Thus, even when a difference between a temperature of air taken into the intake opening, such as outside air, and a target temperature in the cultivation chamber increases, energy consumption for controlling a temperature to the target temperature can be effectively reduced.

In addition, a conventional general plant factory is equipped, in a cultivation chamber, with an air conditioner for cooling and heating. Thus, there is a possibility that foreign matter generated by the air conditioner may mix in the cultivation chamber. However, in the air conditioning system for plant cultivation according to the present invention, since the temperature control apparatus is disposed outside the cultivation chamber, foreign matter can be suppressed from entering the cultivation room.

Thus, the plant cultivation chamber can be very economically controlled to a desired condition.

The air conditioning system for plant cultivation according to the present invention may further comprise a mixture-ratio regulating valve unit provided on the air passageway, the mixture-ratio regulating valve unit regulating a mixture ratio between air from the intake opening and air from the return passageway, and supplying the air to the temperature control apparatus.

In this case, the mixture-ratio regulating valve unit can switch, for example, a mode in which air taken from the intake opening is supplied to the temperature control apparatus at a higher ratio than air from the return passageway, a mode in which air from the return passageway is supplied to the temperature control apparatus at a higher ratio than air taken from the intake opening, and a mode in which air taken from the intake opening and air from the return passageway, which are mixed at equal proportions, are supplied to the temperature control apparatus.

For example, when a higher carbon dioxide concentration environment in which a plant may be promoted to grow is desired, the aforementioned structure can efficiently increase a carbon dioxide concentration in the cultivation chamber by supplying air from the return passageway to the temperature control apparatus at a higher ratio than air taken from the intake opening. This can promote the growth of the plant while reducing energy consumption for temperature control.

When a photosynthetic plant does not perform photosynthesis, it inhales air and emits carbon dioxide. Thus, when a photosynthetic plant is cultivated in the cultivation chamber, a carbon dioxide concentration can be efficiently increased by circulating air from the return passageway with a lighting device in the cultivation chamber being turned off.

The air conditioning system for plant cultivation according to the present invention may further comprise a return-flow-rate regulating valve unit that regulates a flow rate ratio between air discharged outside from the cultivation chamber, and air flowing from the cultivation chamber to the return passageway.

In this case, the return-flow-rate regulating valve unit can switch a mode in which air in the cultivation chamber is discharged outside at a higher ratio than air flowing to the return passageway, a mode in which air in the cultivation chamber is allowed to flow to the return passageway at a higher ratio than air discharged outside, and a mode in which air in the cultivation chamber is discharged outside and is allowed to flow to the return passageway at equal proportions. Thus, when a higher carbon dioxide concentration environment is desired, a carbon dioxide concentration in the cultivation chamber can be efficiently increased by allowing air in the cultivation chamber to flow to the return passageway at a higher ratio than air discharged outside. This can promote the growth of the plant while reducing energy consumption for temperature control.

In addition, a branch passageway that divaricates air in the return passageway may be connected to the return passage way, the return passageway being provided with a flow-rate regulating valve that regulates a flow rate of air flowing from the return passage a side of the air passageway, and a flow rate of air flowing from the return passageway to the branch passageway, and the air passageway may be provided with a heat exchanger that heat-exchanges air in the air passageway and air having flown through the branch passageway.

In this case, air from the return passageway can be used to control a temperature of air taken from the intake opening without meeting the air from the return passageway and the air taken from the intake opening. This allows the air from the return passageway to be efficiently used to reduce energy consumption for temperature control, when meeting of air from the return passageway and air taken from the intake opening is not desired.

In addition, An air conditioning system for mushroom cultivation comprises:

an air passageway having an intake opening for taking air thereinto, and a supply opening connected to a cultivation chamber for cultivating a mushroom;

a temperature control apparatus that controls a temperature of air flowing through the air passageway;

a return passageway for returning air in the cultivation chamber to the air passageway between the intake opening and a position at which the temperature control apparatus controls air in temperature; and

a mixture-ratio regulating valve unit provided on the air passageway, the mixture-ratio regulating valve unit regulating a mixture ratio between air from the intake opening and air from the return passageway, and supplying the air to the temperature control apparatus.

The air conditioning system for mushroom cultivation allows air having been controlled in temperature by the temperature control apparatus and supplied to the cultivation chamber to be returned through the return passageway to the air passageway between the intake opening and the temperature control position by the temperature control apparatus, so that air taken from the intake opening and air having already been controlled in temperature by the temperature control apparatus can be met. This allows a temperature of the air controlled in temperature by the temperature control apparatus to come close to a target temperature. Thus, even when a difference between a temperature of air taken into the intake opening, such as outside air, and the target temperature in the cultivation chamber increases, energy consumption for controlling a temperature to a target temperature can be effectively reduced.

In addition, the mixture-ratio regulating valve unit can switch, for example, a mode in which air taken from the intake opening is supplied to the temperature control apparatus at a higher ratio than air from the return passageway, a mode in which air from the return passageway is supplied to the temperature control apparatus at a higher ratio than air taken from the intake opening, and a mode in which air taken from the intake opening and air from the return passageway, which are mixed at equal proportions, are supplied to the temperature control apparatus. In the cultivation of mushrooms, it is known that a carbon dioxide concentration in a cultivation chamber affects a shape and size of the mushrooms. An optimum carbon dioxide concentration for mushrooms varies depending on the stage of growth. When a higher carbon dioxide concentration environment is desired, for example, the air conditioning system for mushroom cultivation according to the present invention can efficiently increase a carbon dioxide concentration in the cultivation chamber by supplying air from the return passageway to the temperature control apparatus at a higher ratio than air taken from the intake opening, whereby the mushrooms can grow in a desired environment. Since the mushroom is a plant that absorbs air and emits carbon dioxide, the control of increase in carbon dioxide concentration in the air conditioning system for mushroom cultivation according to the present invention can use the carbon dioxide generated by the mushrooms themselves, which is extremely economical.

On the other hand, when a carbon dioxide concentration in the cultivation chamber is desired to be decreased according to the stage of growth of mushrooms, a lower carbon dioxide concentration environment can be quickly created by increasing air flowing from the intake port and supplying the air to the temperature control apparatus.

In addition, a conventional general plant factory is equipped, in a cultivation chamber, with an air conditioner for cooling and heating. Thus, there is a possibility that foreign matter generated by the air conditioner may mix in the cultivation chamber. However, in the air conditioning system for mushroom cultivation according to the present invention, since the temperature control apparatus is disposed outside the cultivation chamber, foreign matter can be suppressed from entering the cultivation room.

Thus, the mushroom cultivation chamber can be very economically controlled to a desired condition, and the finish of the mushrooms can be economically improved.

The air conditioning system for mushroom cultivation according to the present invention may further comprise a return-flow-rate regulating valve unit that regulates a flow rate ratio between air discharged outside from the cultivation chamber, and air flowing from the cultivation chamber to the return passageway.

In this case, the return-flow-rate regulating valve unit can switch a mode in which air in the cultivation chamber is discharged outside at a higher ratio than air flowing to the return passageway, a mode in which air in the cultivation chamber is allowed to flow to the return passageway at a higher ratio than air discharged outside, and a mode in which air in the cultivation chamber is discharged outside and is allowed to flow to the return passageway at equal proportions. Thus, when a higher carbon dioxide concentration environment is desired, for example, a carbon dioxide concentration in the cultivation chamber can be efficiently increased by allowing air in the cultivation chamber to flow to the return passageway at a higher ratio than air discharged outside. This can promote the growth of mushrooms in a desired environment while effectively reducing energy consumption for temperature control.

In addition, an air conditioning system with carbon dioxide concentration regulating function according to the present invention comprises:

an air passageway having an intake opening for taking air thereinto, and a supply opening connected to a space to be controlled in temperature;

a temperature control apparatus that controls a temperature of air flowing through the air passageway;

a return passageway for returning air in the space to be controlled in temperature to the air passageway between the intake opening and a position at which the temperature control apparatus controls air in temperature;

a mixture-ratio regulating valve unit provided on the air passageway, the mixture-ratio regulating valve unit regulating a mixture ratio between air from the intake opening and air from the return passageway, and supplying the air to the temperature control apparatus; and

a control device that controls the mixture-ratio regulating valve;

wherein:

the control device is capable of switching a control by a first mode in which a carbon dioxide concentration of air in the space to be controlled in temperature is increased, and a control by a second mode in which a carbon dioxide concentration of air in the space to be controlled in temperature is decreased;

in the first mode, the mixture-ratio regulating valve unit is controlled such that air from the return passageway is supplied to the temperature control apparatus at a higher ratio than air taken from the intake opening; and

in the second mode, the mixture-ratio regulating valve unit is controlled such that air taken from the intake opening is supplied to the temperature control apparatus at a higher ratio than air from the return passageway.

The air conditioning system with carbon dioxide concentration regulating function according to the present invention can be efficiently used in environments where controls of increase and decrease in carbon dioxide concentration are desired.

In addition, another air conditioning system for plant cultivation according to the present invention comprises:

a switching valve having an intake port, a supply port, a return port, and a discharge port;

an air passageway that connects the supply port and a cultivation chamber for cultivating a plant; and

a return passageway that connects the return port and the cultivation chamber;

wherein the switching valve is capable of operating between a first position at which the switching valve connects the intake port and the supply port, connects the return port and the discharge port, and disconnects the return port and the supply port, and a second position at which the switching valve connects the return port and the supply port, disconnects the intake port and the supply port, and disconnects the return port and the discharge port.

In the air conditioning system for plant cultivation according to the present invention, when the switching valve switches the first position and the second position, it is possible to switch a mode in which air flowing from the intake port to the supply port is allowed to flow to the air passageway at a higher ratio than air flowing from the cultivation chamber to the supply port through the return port, and a mode in which air flowing from the cultivation chamber to the supply port through the return port is allowed to flow to the air passageway at a higher ratio than air flowing from the intake port to the supply port.

When a higher carbon dioxide concentration environment in which a plant may be promoted to grow is desired, the aforementioned structure allows air flowing from the cultivation chamber to the supply port through the return port, to flow to the air passageway at a higher ratio than air flowing from the the intake port to the supply port. This allows a carbon dioxide concentration in the cultivation chamber to be increased with a simple structure and operation. Thus, an environment desirable to the growth of plants can be very easily and economically created.

When a photosynthetic plant does not perform photosynthesis, it inhales air and emits carbon dioxide. Thus, when a photosynthetic plant is cultivated in the cultivation chamber, a carbon dioxide concentration can be efficiently increased by circulating air from the return passageway with a lighting device in the cultivation chamber being turned off.

In addition, in the air conditioning system for plant cultivation according to this embodiment, since the return passageway constitutes a part of a path for discharging air in the cultivation chamber, the entire system can be simplified as compared with a case in which a separate passageway for discharge is used.

Thus, the plant cultivation chamber can be very economically controlled to a desired condition.

The other air conditioning system for plant cultivation according to the present invention may further comprise a temperature control apparatus that controls a temperature of air flowing through the air passageway.

In this case, air having been controlled in temperature by the temperature control apparatus and having been supplied to the cultivation chamber can be returned from the return passageway through the return port of the switching valve to the upstream of the temperature control position by the temperature control apparatus. This allows a temperature of the air controlled in temperature by the temperature control apparatus to come close to a target temperature in the cultivation chamber, whereby energy consumption for controlling a temperature to the target temperature can be effectively reduced. In addition, when the switching valve mixes air flowing from the intake port to the supply port, and air flowing from the cultivation chamber to the supply port through the return port, a temperature of air controlled by the temperature control apparatus similarly comes close to the target temperature. Thus, even when a difference between a temperature of air taken into the intake opening, such as outside air, and the target temperature in the cultivation chamber increases, energy consumption for controlling a temperature to the target temperature can be effectively reduced.

In addition, a conventional general plant factory is equipped, in a cultivation chamber, with an air conditioner for cooling and heating. Thus, there is a possibility that foreign matter generated by the air conditioner may mix in the cultivation chamber. However, in the air conditioning system for mushroom cultivation according to the present invention, since the temperature control apparatus is disposed outside the cultivation chamber, foreign matter can be suppressed from entering the cultivation room.

The switching valve may be capable of being further switched to an intermediate position between the first position and the second position, and the switching valve located at the intermediate position may connect the intake port and the supply port, connect the return port and the supply port, and connect the return port and the discharge port, so as to allow air, which is mixture of air flowing from the intake port to the supply port and air flowing from the cultivation chamber to the supply port through the return port, to flow to the air passageway.

In this case, the operation patterns upon carbon dioxide concentration regulation and upon temperature control can be increased.

In addition, as the switching valve located at the intermediate position moves from the first position side to the second position side, the switching valve may decrease a proportion of air flowing from the intake port to the supply port with respect to air flowing from the cultivation chamber to the supply port through the return port, and as the switching valve located at the intermediate position moves from the second position side to the first position side, the switching valve may decrease a proportion of air flowing from the cultivation chamber to the supply port through the return port with respect to air flowing from the intake port to the supply port.

The switching valve may disconnect the intake port and the discharge port both at the first position and at the second position.

The switching valve may disconnect the intake port and the discharge port at the first position, and may connect the intake port and the discharge port at the second position.

In addition, the other air conditioning system for plant cultivation according to the present invention may further comprise: an intake passageway connected to the intake port; and a discharge passageway connected to the discharge port;

wherein a part of the intake passageway and a part of the discharge passageway constitute a total heat exchanger that heat-exchanges air flowing through the intake passageway and air flowing through the discharge passageway.

In addition, another air conditioning system for mushroom cultivation according to the present invention comprises:

a switching valve having an intake port, a supply port, a return port, and a discharge port;

an air passageway that connects the supply port and a cultivation chamber for cultivating a mushroom; and

a return passageway that connects the return port and the cultivation chamber;

wherein the switching valve is capable of operating between a first position at which the switching valve connects the intake port and the supply port, connects the return port and the discharge port, and disconnects the return port and the supply port, and a second position at which the switching valve connects the return port and the supply port, disconnects the intake port and the supply port, and disconnects the return port and the discharge port.

In the other air conditioning system for mushroom cultivation according to the present invention, when the switching valve switches the first position and the second position, it is possible to switch a mode in which air flowing from the intake port to the supply port is allowed to flow to the air passageway at a higher ratio than air flowing from the cultivation chamber to the supply port through the return port, and a mode in which air flowing from the cultivation chamber to the supply port through the return port is allowed to flow to the air passageway at a higher ratio than air flowing from the intake port to the supply port. In the cultivation of mushrooms, it is known that a carbon dioxide concentration in a cultivation chamber affects a shape and size of the mushrooms. An optimum carbon dioxide concentration for mushrooms varies depending on the stage of growth. When a higher carbon dioxide concentration environment is desired, for example, the air conditioning system for mushroom cultivation according to the present invention can efficiently increase a carbon dioxide concentration in the cultivation chamber by allowing air flowing from the cultivation chamber to the supply port through the return port to flow to the air passageway at a higher ratio than air flowing from the intake port to the supply port. This allows a carbon dioxide concentration in the cultivation chamber to be increased with a simple structure and operation. Thus, an environment desirable to the growth of mushrooms can be very easily and economically created. Since the mushroom is a plant that absorbs air and emits carbon dioxide, the control of increase in carbon dioxide concentration in the air conditioning system for mushroom cultivation according to the present invention can use the carbon dioxide generated by the mushrooms themselves, which is extremely economical.

On the other hand, when a carbon dioxide concentration in the cultivation chamber is desired to be decreased according to the stage of growth of mushrooms, a lower carbon dioxide concentration environment can be quickly created by increasing air flowing from the intake port to the supply port.

Thus, the mushroom cultivation chamber can be very economically controlled to a desired condition, and the finish of the mushrooms can be economically improved.

In addition, another air conditioning system with carbon dioxide concentration regulating function according to the present invention comprises:

a switching valve having an intake port, a supply port, a return port, and a discharge port;

an air passageway that connects the supply port and a space to be controlled in temperature;

a return passageway that connects the return port and the space to be controlled in temperature; and

a control device that controls the switching valve;

wherein:

the switching valve is capable of operating between a first position at which the switching valve connects the intake port and the supply port, connects the return port and the discharge port, and disconnects the return port and the supply port, and a second position at which the switching valve connects the return port and the supply port, disconnects the intake port and the supply port, and disconnects the return port and the discharge port;

the control device is capable of switching a control by a first mode in which a carbon dioxide concentration of air in the space to be controlled in temperature is increased, and a control by a second mode in which a carbon dioxide concentration of air in the space to be controlled in temperature is decreased;

in the first mode, the switching valve is controlled such that air flowing from the space to be controlled in temperature to the supply port through the return port flows to the air passageway at a higher ratio than air flowing from the intake port to the supply port; and

in the second mode, the switching valve is controlled such that air flowing from the intake port to the supply port flows to the air passageway at a higher ratio than air flowing from the space to be controlled in temperature to the supply port through the return port.

The air conditioning system with carbon dioxide concentration regulating function according to the present invention can be efficiently used in environments where controls of increase and decrease in carbon dioxide concentration are desired.

The present invention enables a space such as a plant cultivation chamber to be very economically controlled to a desired condition.

### BRIEF DESCRIPTION OF THE DRAWINGS

FIG. 1 is a view showing a schematic structure of a mushroom cultivation facility comprising an air conditioning system according to a first embodiment of the present invention.

FIG. 2 is a view showing a schematic structure of a mushroom cultivation facility comprising an air conditioning system according to a second embodiment of the present invention.

FIG. 3 is a view showing a schematic structure of a mushroom cultivation facility comprising an air conditioning system according to a third embodiment of the present invention.

FIG. 4A is a view showing a switching valve installed on the air conditioning system according to the third embodiment.

FIG. 4B is a view showing the switching valve installed on the air conditioning system according to the third embodiment, the switching valve being in a condition different from that of FIG. 4A.

FIG. 4C is a view showing the switching valve installed on the air conditioning system according to the third embodiment, the switching valve being in a condition different from those of FIGS. 4A and 4B.

FIG. 5A is a view showing a switching valve installed on the air conditioning system according to a fourth embodiment.

FIG. 5B is a view showing the switching valve installed on the air conditioning system according to the fourth embodiment, the switching valve being in a condition different from that of FIG. 5A.

FIG. 5C is a view showing the switching valve installed on the air conditioning system according to the fourth embodiment, the switching valve being in a condition different from those of FIGS. 5A and 5B.

### EMBODIMENTS FOR CARRYING OUT THE INVENTION

Respective embodiments of the present invention are described herebelow.

### First Embodiment

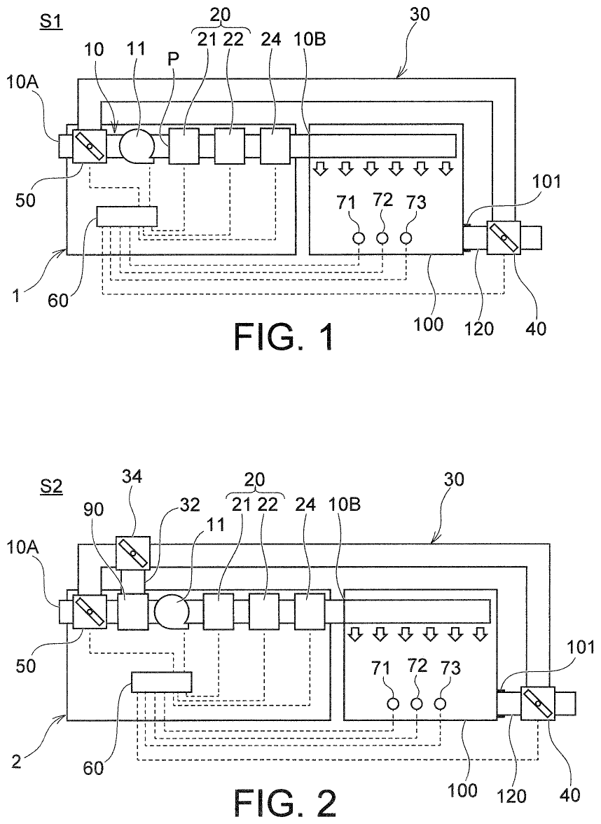

FIG. 1 is a view showing a schematic structure of a mushroom cultivation facility S1 comprising an air conditioning system for mushroom cultivation 1 (abbreviated as “air conditioning system 1” herebelow) according to a first embodiment of the present invention. The mushroom cultivation facility S1 comprises the air conditioning system 1 and a cultivation chamber 100. The cultivation chamber 100 is a room for cultivating mushrooms. The air conditioning system 1 supplies the cultivation chamber 100 with air having been controlled in temperature and humidity. Mushrooms to be cultivated may be, for example, eringi (king oyster), enoki (winter mushroom), maitake (hen-of-the-woods), hiratake (oyster mushroom), nameko, shimeji and the like, but the present invention is not limited thereto.

The air conditioning system 1 comprises an air passageway 10, a blower 11, a temperature control apparatus 20, a humidifier 24, a return passageway 30, a return-flow-rate regulating valve unit 40, a mixture-ratio regulating valve unit 50, a control device 60, a temperature sensor 71, a humidity sensor 72, and a CO₂ concentration sensor 73.

The air passageway 10 has an intake opening 10A for taking thereto air outside the air conditioning system 1, such as outside air, and a supply opening 10B connected to the cultivation chamber 100.

The blower 11 generates a driving force for taking air into the air passageway 10 from the intake opening 10A and allowing the taken-in air to flow to the supply opening 10B.

The temperature control apparatus 20 controls a temperature of air flowing through the air passageway 10. The temperature control apparatus 20 has a cooler 21 that cools air flowing through the air passageway 10, and a heater 22 that heats air flowing through the air passageway 10. For example, the cooler 21 may be an evaporator in a refrigeration circuit of a heat pump type, or may use a Peltier element. The heater 22 may be an electric heater, or may use a high-temperature heat medium circulating in a refrigeration circuit.

In this embodiment, the cooler 21 is disposed upstream of the heater 22 in the air passageway 10, but the present invention is not limited thereto. In addition, the blower 11 is disposed upstream of the cooler 21 and the humidifier 24 is disposed downstream of the heater 22 in the air passageway 10, but the present invention is not limited thereto.

The humidifier 24 humidifies air flowing through the air passageway 10. The humidifier 24 may be a humidifier that mixes air with steam generated by heating water, or may be an ultrasonic humidifier.

The return passageway 30 returns air in the cultivation chamber 100 to the air passageway 10 between the intake opening 10A and a position P at which the temperature control apparatus 20 controls air in temperature (in this example, a position at which the cooler 21 cools air).

In this embodiment, the cultivation chamber 100 is provided with a discharge opening 101, and the air conditioning system 1 further comprises a discharge pipe 120 connected to the discharge opening 101. The return passageway 30 is connected to the discharge pipe 120 so as to branch from the discharge pipe 120.

Here, the return-flow-rate regulating valve unit 40 is provided on the discharge pipe 120, so as to regulate a flaw rate ratio between air discharged outside from the cultivation chamber 100 through the discharge pipe 120, and air flowing from the cultivation chamber 100 to the return passageway 30. The return-flow-rate regulating valve unit 40 can regulate a flow rate ratio between air discharged outside through the discharge pipe 120, and air flowing through the return passageway 30 in a range from 0:100 to 100:0, but the present invention is not limited thereto.

On the other hand, the mixture-ratio regulating valve unit 50 is provided on the air passageway 10 between the intake opening 10A and the position P at which the temperature control apparatus 20 controls air in temperature (in this example, a position at which the cooler 21 cools air), so as to regulate a mixture ratio of air from the intake opening 10A and air from the return passageway 30, and supplies the air to the temperature control apparatus 20. The mixture-ratio regulating valve unit 50 can also regulate a mixture ratio between air from the intake opening 10A and air from the return passageway 30 in a range from 0:100 to 100:0, but the present invention is not limited thereto.

When some or all of air taken from the intake opening 10A is not supplied to the temperature control apparatus 20 under the control of the mixture-ratio regulating valve unit 50, some or all of the air not supplied to the temperature control apparatus 20 is discharged outside from a passageway not shown. Similarly, when some or all of air flowing through return passageway 30 is not supplied to the temperature control apparatus 20 under the control of the mixture-ratio regulating valve unit 50, some or all of the air not supplied to the temperature control apparatus 20 is discharged outside from a passageway not shown. Such a mixture-ratio regulating valve unit 50 may be a 4-port flow-rate regulating valve.

The control device 60 is electrically connected to the temperature senor 71, the humidity sensor 72, and the CO₂ concentration sensor 73, which are disposed in the cultivation chamber 100. The control device 60 is also electrically connected to the blower 11, the temperature control apparatus 20, the humidifier 24, the return-flow-rate regulating valve unit 40, and the mixture-ratio regulating valve unit 50 so as to control operations of the respective members. The control device 60 may be formed of a computer comprising, for example, a CPU, ROM, RAM, etc., and may control operations of the respective members based on a stored program. In addition, the control device 60 may be capable of regulating an intensity of a lighting device in the cultivation chamber and switching on and off the lighting device.

A user can set a target temperature of air in the cultivation chamber 100, a target humidity thereof, a supply airflow rate thereof, and the like, through the control device 60 by an operation means, not shown. The control device 60 regulates a cooling capacity of the cooler 21 and a heating capacity of the heater 22 in accordance with the target temperature, and regulates a humidity amount by the humidifier 24 in accordance with the target humidity. In addition, the control device 60 regulates an airflow rate of the blower 11 in accordance with the set supply airflow rate.

In addition, the control device 60 can switch between a control by a first mode in which a carbon dioxide concentration of air in the cultivation chamber 100 is increased, and a control by a second mode in which a carbon dioxide concentration of air in the cultivation chamber 100 is decreased. In the first mode, the mixture-ratio regulating valve unit 50 is controlled by the control device 60 such that air from the return passageway 30 is supplied to the temperature control apparatus 20 at a higher ratio than air taken from the intake opening 10A. In the second mode, the mixture-ratio regulating valve unit 50 is controlled by the control device 60 such that air taken from the intake opening 10A is supplied to the temperature control apparatus 20 at a higher ratio than air from the return passageway 30.

In the first mode, the mixture-ratio regulating valve unit 50 may be controlled such that only air from the return passageway 30 is supplied to the temperature control apparatus 20. On the other hand, in the second mode, the mixture-ratio regulating valve unit 50 may be controlled such that only air taken from the intake opening 10A is supplied to the temperature control apparatus 20.

In the first mode and the second mode of this embodiment, the control device 60 also controls the return-flow-rate regulating valve unit 40. Specifically, in the first mode and the second mode, the control device 60 matches a mixture ratio between air from the return passageway 30 and air from the intake opening 10A, and a flow rate ratio between air flowing from the cultivation chamber 10 to the return passageway 30 and air discharged outside from the cultivation chamber 100. Thus, in the first mode, when only air from the return passageway 30 is supplied to the temperature control apparatus 20, the return-flow-rate regulating valve unit 40 is controlled to allow air to flow from the cultivation chamber 100 only to the return passageway 30. On the other hand, in the second mode, when only air taken from the intake opening 10A is supplied to the temperature control apparatus 20, the return-flow-rate regulating valve unit 40 is controlled such that no air flows from the cultivation chamber 100 to the return passageway 30.

The aforementioned controls by the first mode and the second mode are carried out, while the control device 60 monitors the CO₂ concentration sensor 73. When air in the cultivation chamber 100 has a target carbon dioxide concentration, in this embodiment, air is supplied to the temperature control apparatus 20 at a mixture ratio between air from the intake opening 10A and air from the return passageway 30, the mixture ratio being capable of maintaining the target CO₂ concentration. In the first mode, the mixture-ratio regulating valve unit 50 may be controlled such that, as a carbon dioxide concentration of air in the cultivation chamber 100 comes close to a target one, air supplied to the temperature control apparatus 20 has an increased ratio of air taken from the intake opening 10A with respect to air from the return passageway 30. In the second mode, the mixture-ratio regulating valve unit 50 may be controlled such that, as a carbon dioxide concentration of air in the cultivation chamber 100 comes close to a target one, in the air supplied to the temperature control apparatus 20, a ratio of air taken from the return passageway 30 with respect to air from the intake opening 10A is increased.

An operation of the embodiment is described herebelow.

The air conditioning system 1 allows air, which has been controlled in temperature by the temperature control apparatus 20 and supplied to the cultivation chamber 100, to be returned through the return passageway 30 to the air passageway 10 between the intake opening 10A and the temperature control position (P) by the temperature control apparatus 20, so that air taken from the intake opening 10A and air having already been controlled in temperature by the temperature control apparatus 20 can be met. This allows a temperature of the air controlled in temperature by the temperature control apparatus 20 to come close to a target temperature. Thus, even when a difference between a temperature of air taken into the intake opening 10A, such as outside air, and a target temperature in the cultivation chamber 100 increases, energy consumption for controlling a temperature to the target temperature can be effectively reduced.

The mixture-ratio regulating valve unit 50 can switch, for example, a mode in which air taken from the intake opening 10A is supplied to the temperature control apparatus 20 at a higher ratio than air from the return passageway 30, a mode in which air from the return passageway 30 is supplied to the temperature control apparatus 20 at a higher ratio than air taken from the intake opening 10, and a mode in which air taken from the intake opening 10A and air from the return passageway 30, which are mixed at equal proportions, are supplied to the temperature control apparatus 20. In the cultivation of mushrooms, it is known that a carbon dioxide concentration in the mushroom cultivation chamber 100 affects a shape and size of mushrooms. An optimum carbon dioxide concentration for mushrooms varies depending on the stage of growth. When a higher carbon dioxide concentration environment is desired, for example, the air conditioning system 1 can efficiently increase a carbon dioxide concentration in the cultivation chamber 100 by supplying air from the return passageway 30 to the temperature control apparatus 20 at a higher ratio than air taken from the intake opening 10A (first mode), whereby the mushrooms can grow in a desired environment. Since the mushroom is a plant that absorbs air and emits carbon dioxide, the control of increase in carbon dioxide concentration in the air conditioning system 1 can use the carbon dioxide generated by the mushrooms themselves, which is extremely economical.

On the other hand, when a carbon dioxide concentration in the cultivation chamber 100 is desired to be decreased according to the stage of growth of mushrooms, a lower carbon dioxide concentration environment can be quickly created by increasing air from the intake opening 10A and supplying it to the temperature control apparatus 20.

A conventional general plant factory is equipped, in a cultivation chamber, with an air conditioner for cooling and heating. Thus, there is a possibility that foreign matter generated by the air conditioner may mix in the cultivation chamber. However, in the air conditioning system 1, since the temperature control apparatus 20 is disposed outside the cultivation chamber 100, foreign matter can be suppressed from entering the cultivation room 100.

According to the air conditioning system 1 in this embodiment, the mushroom cultivation chamber 100 can be very economically controlled to a desired condition, and the finish of the mushrooms can be economically improved.

In addition, the return-flow-rate regulating valve unit 40 can switch a mode in which air in the cultivation chamber 100 is discharged outside at a higher ratio than air flowing to the return passageway 30, a mode in which air in the cultivation chamber 100 is allowed to flow to the return passageway 30 at a higher ratio than air discharged outside, and a mode in which air in the cultivation chamber 100 is discharged outside and is allowed to flow to the return passageway 30 at equal proportions. This makes it possible to efficiently perform the aforementioned control of increase in carbon dioxide concentration in the first mode, and to promote the growth of mushrooms in a desired environment while effectively reducing energy consumption for temperature control.

### Second Embodiment

Next, a mushroom cultivation facility S2 comprising an air conditioning system for mushroom cultivation 2 according to a second embodiment is described with reference to FIG. 2. In the following description, only differences from the first embodiment are described.

As shown in FIG. 2, in this embodiment, a branch passageway 32 that divaricates air in the return passageway 30 is connected to the return passageway 30. In addition, the return passageway 30 is provided with a flow-rate regulating valve 34 that regulates a flow rate of air flowing from the return passageway 30 to a side of the air passageway 10, and a flow rate of air flowing from the return passageway 30 to the branch passageway 32. Further, the air passageway 10 is provided with a heat exchanger 90 that heat-exchanges air in the air passageway 10 and air having flown through the branch passageway 32.

In this second embodiment, air from the return passageway 30 can be used to control a temperature of air taken from the intake opening 10A without meeting the air from the return passageway 30 and the air taken from the intake opening 10A. This allows the air from the return passageway 30 to be efficiently used to reduce energy consumption for temperature control, when meeting of air from the return passageway 30 and air taken from the intake opening 10A is not desired.

### Third Embodiment

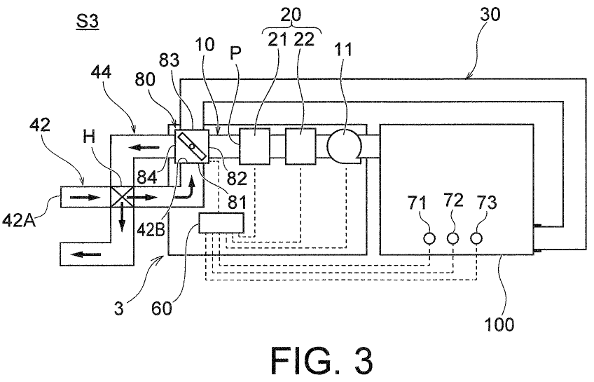

Next, a third embodiment is described. FIG. 3 is a view showing a schematic structure of a mushroom cultivation facility S3 comprising an air conditioning system for mushroom cultivation 3 (abbreviated as “air conditioning system 3” herebelow) according to the third embodiment of the present invention. The mushroom cultivation facility S3 comprises the air conditioning system 3 and a cultivation chamber 100. The cultivation chamber 100 is a room for cultivating mushrooms. The air conditioning system 3 supplies the cultivation chamber 100 with air. Mushrooms to be cultivated may be, for example, eringi, enoki, maitake, hiratake, nameko, shimeji and the like, but the present invention is not limited thereto. In the below example, the same symbols are given to the same constituent elements of this embodiment as those of the first and second embodiments.

The air conditioning system 3 comprises a switching valve 80, an air passageway 10, a blower 11, a temperature control apparatus 20, a return passageway 30, an intake passageway 42, a discharge passageway 44, a control device 60, a temperature sensor 71, a humidifier sensor 72, and a CO₂ concentration sensor 73.

The switching valve 80 is a four-way valve, for example, and has an intake port 81, a supply port 82, a return port 83, and a discharge port 84. The illustrated switching valve 80 is a single valve.

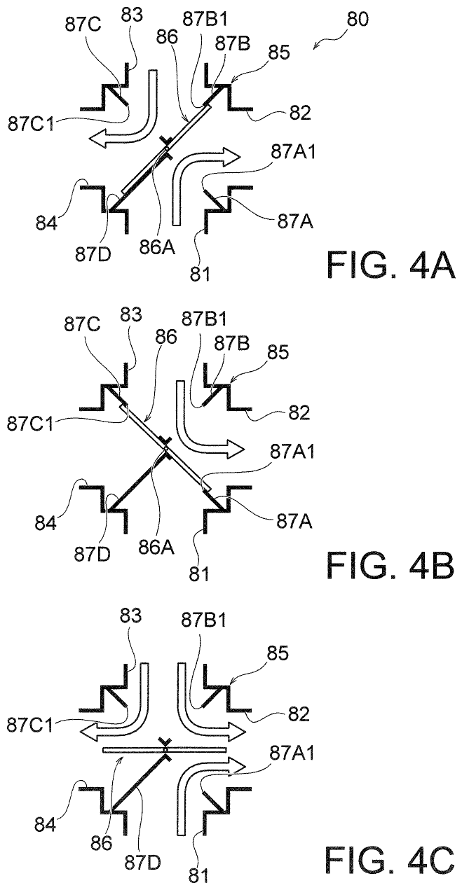

FIGS. 4A to 4C are views schematically showing a structure of the switching valve 80. The switching valve 80 has a valve body 85, and a valve disc 86 rotatably disposed in the valve body 85. The aforementioned intake port 81, the supply port 82, the return port 83, and the discharge port 84 are provided in the valve body 85. In addition, dividers 87A to 87D are provided inside the valve body 85. The dividers 87A to 87D switch passageways according to contact with or separation from the valve body 86.

The valve disc 86 is plate-shaped, and has a rotation axis 86A in the center between mutually opposing end edges of its. The valve disc 86 is rotatable about the rotation axis 86A. The valve disc 86 is connected to a drive unit such as a motor, which is not shown. The drive unit is controlled by the control device 60, so that a rotational position of the valve disc 86 is regulated.

The intake port 85, the supply port 82, the return port 83, and the discharge port 84 provided in the valve body 85 are disposed on an outer circumferential part of the valve body 85 in this order in a rotation direction about the rotation axis 86A.

The first divider 87A of the dividers 87A to 87D extends from an inner wall surface of the valve body 85 at a position between the intake port 81 and the supply port 82 to a position near the rotation axis 86A, and the second divider 87B extends from the inner wall surface of the valve body 85 at a position between the supply port 82 and the return port 83 to a position near the rotation axis 86A. The third divider 87C of the dividers 87A to 87D extends from the inner wall surface of the valve body 85 at a position between the return port 83 and the discharge port 84 to a position near the rotation axis 86A, and the fourth divider 87D extends from the inner wall surface of the valve body 85 at a position between the discharge port 84 and the intake port 81 to a position near the rotation axis 86A.

An end of the first divider 87A on the rotation axis 86A side and an end of the fourth divider 87D on the rotation axis 86A side are coupled to each other, and an end of the second divider 87B on the rotation axis 86A side and an end of the third divider 87C on the rotation axis 86A side are coupled to each other. When seen along a direction along the rotation axis 86A, the end of the first divider 87A on the rotation axis 86A side and the end of the fourth divider 87D on the rotation axis 86A side, which are coupled to each other, and the end of the second divider 87B on the rotation axis 86A side and the end of the third divider 87C on the rotation axis 86A side, which are coupled to each other, are located so as to face each other across the rotation axis 86A.

Apertures 87A1, 87B1, 87C1 are formed in the first divider 87A, the second divider 87B, and the third divider 87C, respectively. In this embodiment, no opening is formed in the fourth divider 87D. A plate portion of the valve disc 86 on one side with respect to the rotation axis 86A is disposed in a space between the first divider 87A and the second divider 87B, and a plate portion of the valve disc 86 on the other side with respect to the rotation axis 86A is disposed in a space between the third divider 87C and the fourth divider 87D.

The above structure makes it possible for the switching valve 80 to create a state in which, as shown in FIG. 4A, the valve disc 86 is separated from the first divider 87A and the third divider 87C to open the aperture 87A1 of the first divider 87A and the aperture 87C1 of the third divider 87C, while the valve disc 86 is in contact with the second divider 87B and the fourth divider 87D to close the aperture 87B1 of the second divider 87B. In addition, as shown in FIG. 4B, the switching valve 80 can create a state in which the valve disc 86 is separated from the second divider 87B to open the aperture 87B1 of the second divider 87B, while the valve disc 86 is in contact with the first divider 87A and the third divider 87c to close the aperture 87A1 of the first divider 87A and the aperture 87C1 of the third divider 87C.

Thus, the switching valve 80 can be operated between a first position (FIG. 4A) at which the switching valve 80 connects the intake port 81 and the supply port 82, connects the return port 83 and the discharge port 84, and disconnects the return port 83 and the supply port 82, and a second position (FIG. 4B) at which the switching valve 80 connects the return port 83 and the supply port 82, disconnects the intake port 81 and the supply port 82, and disconnects the return port 83 and the discharge port 84.

Further, as shown in FIG. 4C, the switching valve 80 can be further switched to an intermediate position between the first position and the second position. The switching valve 80 located at the intermediate position connects the intake port 81 and the supply port 82, connects the return port 83 and the supply port 82, and connects the return port 83 and the discharge port 84. As described above, in this embodiment, since no opening is formed in the fourth divider 87D, the switching valve 80 disconnects the intake port 81 and the discharge port 84 at all of the first position, the second position, and the intermediate position.

Returning to FIG. 3, the air passageway 10 connects the supply port 82 of the switching valve 80 and the cultivation chamber 100. In the air passageway 10, air flows from the switching valve 80 toward the cultivation chamber 100. The temperature control apparatus 20 and the blower 11 are disposed in the air passageway 10. In this embodiment, the blower 11 is disposed downstream of the temperature control apparatus 20 in the air flowing direction, but the present invention is not limited thereto.

The temperature control apparatus 20 controls a temperature of air flowing through the air passageway 10. The temperature control apparatus 20 has a cooler 21 that cools air flowing though the air passageway 10, and a heater 22 that heats air flowing through the air passageway 10. For example, the cooler 21 may be an evaporator in a refrigeration circuit of a heat pump type, or may use a Peltier element. The heater 22 may be an electric heater, or may use a high-temperature heat medium circulating in a refrigeration circuit. In this example, the cooler 21 is disposed upstream of the heater 22 in the air passageway 10, but the present invention is not limited thereto.

The blower 11 generates a driving force for allowing air from the supply port 82 of the switching valve 80 to flow to the cultivation chamber 100.

The return passageway 30 connects the return port 83 and the cultivation chamber 100 to return air in the cultivation chamber 100 to the upstream of a position P at which the temperature control apparatus 20 controls air in temperature (in this example, a position at which the cooler 21 cools air).

The intake passageway 42 has an air intake opening 42A and a connection opening 42B to which the intake port 81 is connected. The air intake opening 42B allows air outside the air conditioning system 3 to be taken into the air conditioning supply system 3, when the blower 11 is driven. The discharge passageway 44 is connected to the discharge port 84 so that air can be discharged outside from the inside of the air conditioning system 3. Here, in this embodiment, a part of the intake passageway 42 and a part of the discharge passageway 44 constitute a heat exchanger, in this example, a total heat exchanger H that heat-exchanges air flowing through the intake passageway 42 and air flowing through the discharge passageway 44.

The term “outside” simply referred to in the below description means an outside of the air conditioning system 3. In this embodiment, the tubular intake passageway 42 and the discharge passageway 44 are connected to the switching valve 80, but they may not be connected to the switching valve 80. In this case, air may be taken from outside directly by the intake port 81, and air may be discharged outside directly from the discharge port 84. In addition, the intake passageway 42 and the discharge passageway 44 may not cooperate with each other to constitute a heat exchanger.

By connecting, to the switching valve 80, the air passageway 10, the return passageway 30, the intake passageway 42, and the discharge passageway 44, the switching valve 80 located at the first position shown in FIG. 4A allows air having passed the intake passageway 42 to flow from the intake port 81 to the supply port 82, to flow to the air passageway 10 at a higher ratio than air flowing from the cultivation chamber 100 to the supply port 82 through the return port 83 (specifically in this example, former:latter is 100:0). In addition, the switching valve 80 located at the second position allows air flowing from the cultivation chamber 100 to the supply port 82 through the return port 83, to flow to the air passageway 10 at a higher ratio than air having passed the intake passageway 42 to flow from the intake port 81 to the supply port 82 (specifically in this example, former:latter is 100:0).

In addition, the switching valve 80 located at the intermediate position shown in FIG. 4C allows air having passed the intake passageway 42 to flow from the intake port 81 to the supply port 82, and air flowing from the cultivation chamber 100 to the supply port 82 through the return port 83, to be mixed, so that the mixed air can flow to the air passageway 10.

In this embodiment, the switching valve 80 is configured as a proportional valve. Thus, as the switching valve 80 located at the intermediate position moves from the first position side toward the second position side, the switching valve 80 decreases a proportion of the air flowing from the intake port 81 to the supply port 82 with respect to the air flowing from the cultivation chamber 100 to the supply port 82 through the return port 83. On the other hand, as the switching valve 80 located at the intermediate position moves from the second position side toward the first position side, the switching valve 80 decreases a proportion of the air flowing from the cultivation chamber 100 to the supply port 82 through the return port 83 with respect to the air flowing from the intake port 81 to the supply port 82. FIGS. 3 and 4A to 4C show some arrows for explaining the air flow.

The control device 60, which is a controller, a processer, an electrical circuit, etc., is electrically connected to the temperature sensor 71, the humidity sensor 72, and the CO₂ concentration sensor 73, which are disposed in the cultivation chamber 100. The control device 60 is also electrically connected to the blower 11, the temperature control apparatus 20, and the switching valve 80 so as to control operations of the respective members. The control device 60 may be formed of a computer comprising, for example, a CPU, ROM, RAM, etc., and may control operations of the respective members based on a stored program. In addition, the control device 60 may be capable of regulating an intensity of a lighting device in the cultivation chamber and switching on and off the lighting device.

A user can set a target temperature of air in the cultivation chamber 100, a target humidity thereof, a supply flow rate thereof, and the like, through the control device 60 by an operation means, not shown. The control device 60 regulates a cooling capacity of the cooler 21 and a heating capacity of the heater 22 in accordance with the target temperature, and regulates a humidifying amount by the humidifier 24 in accordance with the target humidity. In addition, the control device 60 regulates an airflow rate of the blower 11 in accordance with the set supply airflow rate.

In addition, the control device 60 can switch the control by the first mode in which a carbon dioxide concentration of air in the cultivation chamber 100 is increased, and the control by the second mode in which a carbon dioxide concentration of air in the cultivation chamber 100 is decreased. In the first mode, the switching valve 80 is controlled such that air flowing from the cultivation chamber 100 to the supply port 82 through the return port 83 flows to the air passageway 10 at a higher ratio than air flowing from the intake port 81 to the supply port 82. In the second mode, the switching valve 80 is controlled such that air flowing from the intake port 81 to the supply port 82 flows to the air passageway 10 at a higher ratio than air flowing from the cultivation chamber 100 to the supply port 82 through the return port 83.

In the first mode, the switching valve 80 may be controlled such that only air from the return passageway 30 flows to the air passageway 10. On the other hand, in the second mode, the switching valve 80 may be controlled such that only air taken from the air intake opening 42A flows to the air passageway 10.

The aforementioned controls by the first mode and the second mode are carried out, while the control device 60 monitors the CO₂ concentration sensor 73.

An operation of this embodiment is described below.

The air conditioning system 3 allows air, which has been controlled in temperature by the temperature control apparatus 20 and supplied to the cultivation chamber 100, to be returned from the return passageway 30 through the return port 83 of the switching valve 80 to the upstream of the temperature control position (P) by the temperature control apparatus 20. This allows a temperature of the air controlled in temperature by the temperature control apparatus 20 to come close to a target temperature, whereby energy consumption for controlling a temperature to the target temperature can be effectively reduced.

In addition, when the switching valve 80 switches the first position shown in FIG. 4A and the second position shown in FIG. 4B, it is possible to switch the mode in which air flowing from the intake port 81 to the supply port 82 is allowed to flow to the air passageway 10 at a higher ratio than air flowing from the cultivation chamber 100 to the supply port 82 through the return port 83, and the mode in which air flowing from the cultivation chamber 100 to the supply port 82 through the return port 83 is allowed to flow to the air passageway 10 at a higher ratio than air flowing from the intake port 81 to the supply port 82. In the cultivation of mushrooms, it is known that a carbon dioxide concentration in the mushroom cultivation chamber 100 affects a shape and size of mushrooms. An optimum carbon dioxide concentration for mushrooms varies depending on the stage of growth. When a higher carbon dioxide concentration environment is desired, for example, the air conditioning system 3 according to this embodiment allows air flowing from the cultivation chamber 100 to the supply port 82 through the return port 83, to flow to the air passageway at a higher ratio than air flowing from the intake port 81 to the supply port 82. This allows a carbon dioxide concentration in the cultivation chamber 100 to be increased with a simple structure and operation. Thus, an environment desirable to the growth of mushrooms can be very easily and economically created. Since the mushroom is a plant that absorbs air and emits carbon dioxide, the control of increase in carbon dioxide concentration in the air conditioning system 1 can use the carbon dioxide generated by the mushrooms themselves, which is extremely economical.

On the other hand, when a carbon dioxide concentration in the cultivation chamber 100 is desired to be decreased according to the stage of growth of mushrooms, a lower carbon dioxide concentration environment can be quickly created by increasing air flowing from the intake port 81 to the supply port 82.

In addition, in the air conditioning system 3 according to this embodiment, since the return passageway 30 constitutes a part of a path for discharging air in the cultivation chamber 100, the entire system can be simplified as compared with a case in which a separate passageway for discharge is used.

According to the air conditioning system 3 in this embodiment, the mushroom cultivation chamber 100 can be very economically controlled to a desired condition, and the finish of the mushrooms can be economically improved.

### Fourth Embodiment

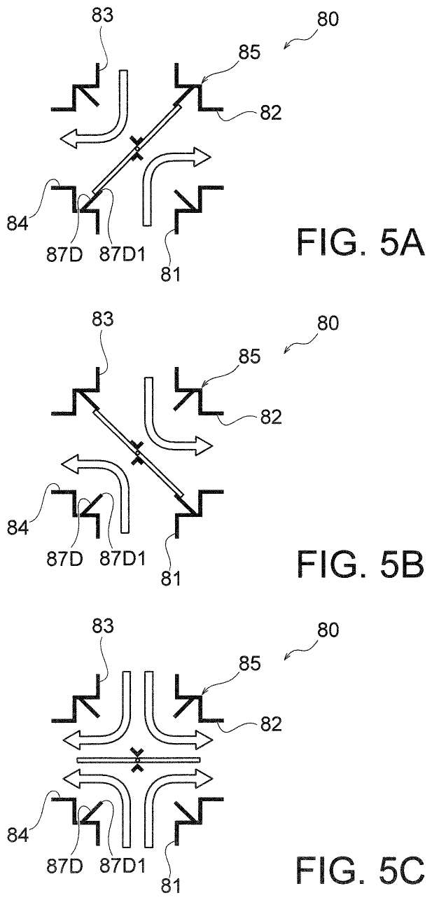

Next, An air conditioning system for mushroom cultivation according to a fourth embodiment is described with reference to FIG. 5. In the following description, only differences from the third embodiment are described.

FIG. 5 is a view showing a switching valve 80 provided on the air conditioning system according to the fourth embodiment. In the switching valve 80 in this embodiment, an opening 87D1 is formed in a fourth divider 87D. In this case, at a first position shown in FIG. 5A, the switching valve 80 connects an intake port 81 and a supply port 82, connects a return port 83 and a discharge port 84, disconnects the return port 83 and the supply port 82, and disconnects the intake port 81 and the discharge port 84.

In addition, at a second position shown in FIG. 5B, the switching valve 80 connects the return port 83 and the supply port 82, disconnects the intake port 81 and the supply port 82, connects the intake port 81 and the discharge port 84, and disconnects the return port 83 and the discharge port 84. In addition, at an intermediate position shown in FIG. 5C, the switching valve 80 connects the intake port 81 and the supply port 82, connects the return port 83 and the supply port 82, connects the return port 83 and the discharge port 84, and connects the intake port 81 and the discharge port 84.

Although the embodiments of the present invention have been described above, the present invention is not limited to the aforementioned embodiments. The aforementioned embodiments can be variously modified.

For example, although the air conditioning systems according to the aforementioned respective embodiments are applied to the cultivation of mushrooms, these air conditioning systems may be used for plant factories of plants other than mushrooms. In addition, the air conditioning systems according to the aforementioned respective embodiments can be efficiently used as air conditioning systems with carbon dioxide concentration regulating function, in environments where controls of increase and decrease in carbon dioxide concentration are desired.

1. An air conditioning system for plant cultivation comprising:
an air passageway having an intake opening for taking air thereinto, and a supply opening connected to a cultivation chamber for cultivating a plant;
a temperature control apparatus that controls a temperature of air flowing through the air passageway; and
a return passageway for returning air in the cultivation chamber to the air passageway between the intake opening and a position at which the temperature control apparatus controls air in temperature.

2. The air conditioning system for plant cultivation according to claim 1, further comprising a mixture-ratio regulating valve unit provided on the air passageway, the mixture-ratio regulating valve unit regulating a mixture ratio between air from the intake opening and air from the return passageway, and supplying the air to the temperature control apparatus.

3. The air conditioning system for plant cultivation according to claim 2, further comprising a return-flow-rate regulating valve unit that regulates a flow rate ratio between air discharged outside from the cultivation chamber, and air flowing from the cultivation chamber to the return passageway.

4. The air conditioning system for plant cultivation according to claim 1, wherein:
a branch passageway that divaricates air in the return passageway is connected to the return passage way, the return passageway being provided with a flow-rate regulating valve that regulates a flow rate of air flowing from the return passage to a side of the air passageway, and a flow rate of air flowing from the return passageway to the branch passageway; and
the air passageway is provided with a heat exchanger that heat-exchanges air in the air passageway and air having flown through the branch passageway.

5. An air conditioning system for mushroom cultivation comprising:
an air passageway having an intake opening for taking air thereinto, and a supply opening connected to a cultivation chamber for cultivating a mushroom;
a temperature control apparatus that controls a temperature of air flowing through the air passageway;
a return passageway for returning air in the cultivation chamber to the air passageway between the intake opening and a position at which the temperature control apparatus controls air in temperature; and
a mixture-ratio regulating valve unit provided on the air passageway, the mixture-ratio regulating valve unit regulating a mixture ratio between air from the intake opening and air from the return passageway, and supplying the air to the temperature control apparatus.

6. The air conditioning system for mushroom cultivation according to claim 5, further comprising a return-flow-rate regulating valve unit that regulates a flow rate ratio between air discharged outside from the cultivation chamber, and air flowing from the cultivation chamber to the return passageway.

7. An air conditioning system with carbon dioxide concentration regulating function comprising:
an air passageway having an intake opening for taking air thereinto, and a supply opening connected to a space to be controlled in temperature;
a temperature control apparatus that controls a temperature of air flowing through the air passageway;
a return passageway for returning air in the space to be controlled in temperature to the air passageway between the intake opening and a position at which the temperature control apparatus controls air in temperature;
a mixture-ratio regulating valve unit provided on the air passageway, the mixture-ratio regulating valve unit regulating a mixture ratio between air from the intake opening and air from the return passageway, and supplying the air to the temperature control apparatus; and
a control device that controls the mixture-ratio regulating valve;
wherein:
the control device is capable of switching a control by a first mode in which a carbon dioxide concentration of air in the space to be controlled in temperature is increased, and a control by a second mode in which a carbon dioxide concentration of air in the space to be controlled in temperature is decreased;
in the first mode, the mixture-ratio regulating valve unit is controlled such that air from the return passageway is supplied to the temperature control apparatus at a higher ratio than air taken from the intake opening; and
in the second mode, the mixture-ratio regulating valve unit is controlled such that air taken from the intake opening is supplied to the temperature control apparatus at a higher ratio than air from the return passageway.

8. An air conditioning system for plant cultivation comprising:
a switching valve having an intake port, a supply port, a return port, and a discharge port;
an air passageway that connects the supply port and a cultivation chamber for cultivating a plant; and
a return passageway that connects the return port and the cultivation chamber;
wherein the switching valve is capable of operating between a first position at which the switching valve connects the intake port and the supply port, connects the return port and the discharge port, and disconnects the return port and the supply port, and a second position at which the switching valve connects the return port and the supply port, disconnects the intake port and the supply port, and disconnects the return port and the discharge port.

9. The air conditioning system for plant cultivation according to claim 8, further comprising a temperature control apparatus that controls a temperature of air flowing through the air passageway.

10. The air conditioning system for plant cultivation according to claim 8, wherein:
the switching valve is capable of being further switched to an intermediate position between the first position and the second position, and
the switching valve located at the intermediate position connects the intake port and the supply port, connects the return port and the supply port, and connects the return port and the discharge port, so as to allow air, which is mixture of air flowing from the intake port to the supply port and air flowing from the cultivation chamber to the supply port through the return port, to flow to the air passageway.

11. The air conditioning system for plant cultivation according to claim 10, wherein
as the switching valve located at the intermediate position moves from the first position side to the second position side, the switching valve decreases a proportion of air flowing from the intake port to the supply port with respect to air flowing from the cultivation chamber to the supply port through the return port, and
as the switching valve located at the intermediate position moves from the second position side to the first position side, the switching valve increases a proportion of air flowing from the cultivation chamber to the supply port through the return port with respect to air flowing from the intake port to the supply port.

12. The air conditioning system for plant cultivation according to claim 10, wherein
the switching valve disconnects the intake port and the discharge port both at the first position and at the second position.

13. The air conditioning system for plant cultivation according to claim 10, wherein
the switching valve disconnects the intake port and the discharge port at the first position, and connects the intake port and the discharge port at the second position.

14. The air conditioning system for plant cultivation according to claim 8, further comprising:
an intake passageway connected to the intake port; and
a discharge passageway connected to the discharge port; wherein a part of the intake passageway and a part of the discharge passage way constitute a total heat exchanger that heat-exchanges air flowing through the intake passageway and air flowing through the discharge passageway.

15. An air conditioning system for mushroom cultivation comprising:
a switching valve having an intake port, a supply port, a return port, and a discharge port;
an air passageway that connects the supply port and a cultivation chamber for cultivating a mushroom; and
a return passageway that connects the return port and the cultivation chamber;
wherein the switching valve is capable of operating between a first position at which the switching valve connects the intake port and the supply port, connects the return port and the discharge port, and disconnects the return port and the supply port, and a second position at which the switching valve connects the return port and the supply port, disconnects the intake port and the supply port, and disconnects the return port and the discharge port.

16. An air conditioning system with carbon dioxide concentration regulating function, comprising:
a switching valve having an intake port, a supply port, a return port, and a discharge port;
an air passageway that connects the supply port and a space to be controlled in temperature;
a return passageway that connects the return port and the space to be controlled in temperature; and
a control device that controls the switching valve;
wherein:
the switching valve is capable of operating between a first position at which the switching valve connects the intake port and the supply port, connects the return port and the discharge port, and disconnects the return port and the supply port, and a second position at which the switching valve connects the return port and the supply port, disconnects the intake port and the supply port, and disconnects the return port and the discharge port;
the control device is capable of switching a control by a first mode in which a carbon dioxide concentration of air in the space to be controlled in temperature is increased, and a control by a second mode in which a carbon dioxide concentration of air in the space to be controlled in temperature is decreased;
in the first mode, the switching valve is controlled such that air flowing from the space to be controlled in temperature to the supply port through the return port flows to the air passageway at a higher ratio than air flowing from the intake port to the supply port; and
in the second mode, the switching valve is controlled such that air flowing from the intake port to the supply port flows to the air passageway at a higher ratio than air flowing from the space to be controlled in temperature to the supply port through the return port.
